(19) United States
(12) Patent Application Publication
(10) Pub. No.: US 2022/0327831 A1
(43) Pub. Date: Oct. 13, 2022

(54) OPERATION DETECTION METHOD AND APPARATUS FOR INTELLIGENT DEVICE

(71) Applicant: KOUBEI (SHANGHAI) INFORMATION TECHNOLOGY CO., LTD., Shanghai (CN)

(72) Inventor: Jiang LI, Shanghai (CN)

(21) Appl. No.: 17/638,408

(22) PCT Filed: Dec. 23, 2019
(86) PCT No.: PCT/CN2019/127621

§ 371 Date: Feb. 25, 2022

(30) Foreign Application Priority Data
Aug. 29, 2019 (CN) 201910810020.8

(51) Int. Cl. G06V 20/40; G06Q 30/06

(52) U.S. Cl. CPC G06V 20/44; G06V 20/46; G06Q 30/0635

(57) ABSTRACT

The present disclosure discloses an operation detection method and apparatus for an intelligent device. The method includes: monitoring an order state of a current order processed by the intelligent device; collecting a real-time operation picture of the intelligent device at an interval of a preset time according to the order state to obtain a plurality of real-time operation pictures at a plurality of shooting moments; acquiring position coordinates of a plurality of real-time key points of the intelligent device from the plurality of real-time operation pictures; and matching the position coordinates of the plurality of real-time key points with a pre-recorded operation trajectory range, and determining an operation state of the intelligent device according to information of real-time key points falling within the operation trajectory range.

### CROSS REFERENCE TO RELATED APPLICATIONS

This application claims priority to Chinese Patent Application No. 201910810020.8 filed on Aug. 29, 2019 and titled “OPERATION DETECTION METHOD AND APPARATUS FOR INTELLIGENT DEVICE”, the entire contents of which are incorporated herein by reference for all purposes.

### TECHNICAL FIELD

The present disclosure relates to the technical field of device detection, in particular to an operation detection method and apparatus for an intelligent device.

### BACKGROUND

With the development of artificial intelligence technology, it is becoming more and more common to control an intelligent device to perform operation processing through online codes, instead of manual operations. For example, in the catering industry, robots or mechanical arms are used for catering production. Further, the correctness of the online codes can be ensured by monitoring online data and logs. However, this online monitoring method usually cannot detect a real operation of the intelligent device. In the Chinese patent application with the application publication No. CN107322646A, various detection modules are provided on a mechanical arm, and a fault warning is performed to the mechanical arm according to detection data detected by the plurality of detection modules, for example, according to an initial state and an operation state of a lateral movement of the mechanical arm detected by a lateral movement monitoring module, a difference between the operation state and the initial state of the lateral movement is determined, and then whether the mechanical arm has a fault is determined.

However, in the above-mentioned prior art, it is necessary to adjust the hardware or software composition of the mechanical arm, and it is impossible to perform the fault warning for the mechanical arm without the various detection modules, resulting in low detection flexibility.

### SUMMARY

In view of above problems, the present disclosure is proposed to provide an operation detection method and apparatus for an intelligent device to overcome or at least partially solve the above problems.

According to one aspect of the present disclosure, there is provided an operation detection method for an intelligent device, including:

monitoring an order state of a current order processed by the intelligent device;

collecting a real-time operation picture of the intelligent device at an interval of a preset time according to the order state to obtain a plurality of real-time operation pictures at a plurality of shooting moments;

acquiring position coordinates of a plurality of real-time key points of the intelligent device from the plurality of real-time operation pictures; and

matching the position coordinates of the plurality of real-time key points with a pre-recorded operation trajectory range, and determining an operation state of the intelligent device according to information of real-time key points falling within the operation trajectory range.

According to another aspect of the present disclosure, there is provided an operation detection apparatus for an intelligent device, including:

a monitoring module configured to monitor an order state of a current order processed by the intelligent device;

a collecting module configured to collect a real-time operation picture of the intelligent device at an interval of a preset time according to the order state to obtain a plurality of real-time operation pictures at a plurality of shooting moments;

a matching module configured to acquire position coordinates of a plurality of real-time key points of the intelligent device from the plurality of real-time operation pictures and match the position coordinates of the plurality of real-time key points with a pre-recorded operation trajectory range; and

a determining module configured to determine an operation state of the intelligent device according to information of real-time key points falling within the operation trajectory range.

According to another aspect of the present disclosure, there is provided a server, including a processor, a memory, a communication interface and a communication bus, wherein the processor, the memory and the communication interface communicate with each other through the communication bus;

the memory is configured to store at least one executable instruction; and the executable instruction causes the processor to perform operations corresponding to the above-mentioned operation detection methods for the intelligent device.

According to another aspect of the present disclosure, there is provided a non-volatile computer readable storage medium having at least one executable instruction stored thereon, the executable instruction causes a processor to perform operations corresponding to the above-mentioned operation detection method for the intelligent device.

According to yet another aspect of the present disclosure, there is provided a computer program product including a computer program stored on a non-volatile computer storage medium.

According to the operation detection method and apparatus for the intelligent device provided by the present disclosure, by monitoring the order state of the current order processed by the intelligent device, and triggering the shooting and collection of real-time operation pictures according to the order state, the detection of the operation state can be triggered in a certain process of processing the order, so as to detect the operation state of the intelligent device in the process of processing the order; and by matching the position coordinates of the plurality of real-time key points in the plurality of real-time operation pictures captured in the process of processing the order with pre-recorded operation trajectory ranges, the operation state of the intelligent device can be determined by comparing the operation trajectory ranges. It can be seen that, according to the solution of the present embodiment, the operation detection of the intelligent device can be triggered by using the order state, so as to determine whether the intelligent device maintains normal operation in the process of processing the order; and the detection is performed by shooting real-time operation pictures of the intelligent device without providing corresponding detection modules on the intelligent device, the operation of any intelligent device can be detected, thereby improving the flexibility of the detection. In addition, the matching detection is performed according to the operation trajectory ranges, so that the real-time key points have a normal range, thereby avoiding the problem of over-detection.

The foregoing descriptions are merely an overview of the technical solutions of the present disclosure. To more clearly understand the technical features of the present disclosure, the technical means may be implemented in accordance with the content of the specification. In addition, to make the foregoing and other objectives, features, and advantages of the present disclosure more obvious and easier, detailed implementations of the present disclosure are provided below.

### BRIEF DESCRIPTION OF THE DRAWINGS

Various other advantages and benefits are clear to a person of ordinary skill in the art by reading detailed descriptions of preferred implementations below. The accompanying drawings are merely intended to show the preferred implementations and do not constitute a limitation on the present disclosure. In the whole accompanying drawings, the same reference numeral is used for indicating the same component. In the drawings:

FIG. 1 is a flowchart illustrating an embodiment of an operation detection method for an intelligent device of the present disclosure;

FIG. 2 is a flowchart illustrating another embodiment of an operation detection method for an intelligent device of the present disclosure;

FIG. 3a is a schematic diagram illustrating a plurality of operation pictures taken in a production stage of a recording order in a specific embodiment;

FIG. 3b is an integrated diagram illustrating a plurality of key points corresponding to the plurality of operation pictures of FIG. 3a;

FIG. 3c is a schematic diagram illustrating an operation trajectory range formed by movement trajectories of the key points in the production stage of a plurality of recording orders;

FIG. 4 is a schematic structural diagram illustrating an embodiment of an operation detection apparatus for an intelligent device of the present disclosure;

FIG. 5 is a schematic structural diagram illustrating an embodiment of a server of the present disclosure.

### DETAILED DESCRIPTION OF THE EMBODIMENTS

Exemplary embodiments of the present disclosure will be described in more detail below with reference to the accompanying drawings. Although the exemplary embodiments of the present disclosure are shown in the accompanying drawings, it should be understood that the present disclosure can be implemented in various forms and should not be limited by the embodiments set forth herein. Rather, these embodiments are provided to enable a more thorough understanding of the present disclosure and to completely convey the scope of the disclosure to a person skilled in the art.

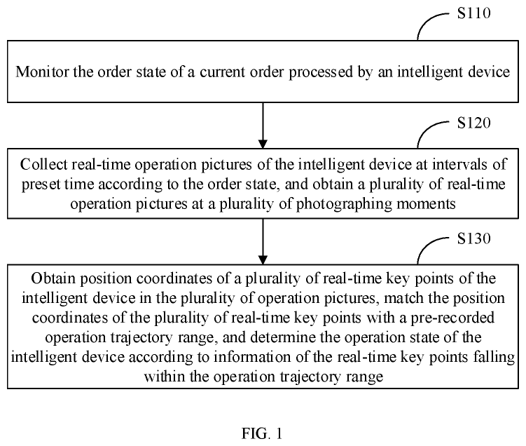

FIG. 1 is a flowchart illustrating an embodiment of an operation detection method for an intelligent device of the present disclosure. The method detects an operation state of the intelligent device through the matching of operation trajectories. As shown in FIG. 1, the method includes the following steps.

Step S110: an order state of a current order processed by the intelligent device is monitored.

The order state can be triggered by a user's operation to change. For example, after the user's payment is completed, the order state can be updated to paid, and/or, the order state can be triggered by an execution progress of online codes to change, where the online codes are codes used to control the processing of the order, for example, if the last step of the production stage has been performed, the order state is updated to production completion.

Specifically, in the process of processing the order, updates of the order state are stored in a backend, which can be a control end in an intelligent store, for example, a KDS (Kitchen Display System) control end, or a server end for order management, for example, a server of an order receiving terminal. By querying the state update of a current order in the backend, the order state of the current order can be monitored.

Step S120: a real-time operation picture of the intelligent device is collected at an interval of a preset time according to the order state to obtain a plurality of real-time operation pictures at a plurality of shooting moments.

In the present disclosure, the collection of the real-time operation picture is triggered by the order state, so as to detect the operation state of the intelligent device in the process of processing the order. The order state can be any state after the payment of the order is completed, for example, a payment completion state, and a production completion (or waiting for delivery) state.

Specifically, when the collection is triggered by the order state, a shooting device is controlled to take the real-time operation picture of the intelligent device at the interval of the preset time for subsequent trajectory matching, wherein a real-time operation picture is taken at the interval of the preset time, and the shooting can be ended according to the number of the real-time operation pictures obtained by shooting and/or the order state updated in real time. For example, when five real-time operation pictures are taken, the shooting ends. For another example, when the order state is updated from payment completion to production completion, the shooting ends. In addition, the shooting device is set at a scene where the intelligent device is located, and the setting position and angle are consistent with the setting when an operation trajectory range is obtained. The shooting device can communicate with an execution entity of the disclosed solution, and send the collected operation pictures to the execution entity; when an end detection event is triggered, the shooting is stopped, and the plurality of real-time operation pictures are collected at this time.

Taking the mechanical arm for making drinks as an example. Assuming that the shooting and collection of pictures are triggered when the payment of a drink is completed, a real-time operation picture of the mechanical arm is taken at a fixed position at the interval of 1 second; when it is detected that the drink has been made at the 5th second, the shooting is stopped and a total of 5 real-time operation pictures corresponding to 0, 1, 2, 3 and 4 seconds are obtained.

Step S130: position coordinates of a plurality of real-time key points of the intelligent device are acquired from the plurality of real-time operation pictures, the position coordinates of the plurality of real-time key points are matched with a pre-recorded operation trajectory range, and an operation state of the intelligent device is determined according to information of real-time key points falling within the operation trajectory range.

The key point can be any fixed point on the intelligent device, however, in some optional embodiments, preferably, the key point is a fixed point of contact with other processing devices, order materials and/or order finished products in the process of processing the order, for example, the key point is a center point of a manipulator of the mechanical arm.

The operation trajectory range refers to a normal operation range of the key points of the intelligent device in the process of historically processing the order, and in the specific implementation process, a corresponding operation trajectory range can be obtained according to a stage of processing the order and/or a type of the order, so as to accurately carry out matching detection.

Specifically, by matching the position coordinates of the plurality of real-time key points with the pre-recorded operation trajectory ranges, the operation state of the intelligent device can be determined according to the number and/or position of the real-time key points falling within the operation trajectory range, that is, the operation state can be determined by comparing the operation trajectory ranges. The specific method of determining the operation state is not limited. Alternatively, the operation state can be determined according to whether all real-time key points fall within the operation trajectory range, or can be determined according to a specific position range where each real-time key point falls within the operation trajectory range.

It should be noted here that, in the present disclosure, the execution entity of the operation detection method is not limited, and the method can be executed by the server or the control end of the store. Alternatively, the method can be executed by a server corresponding to a terminal for receiving an order, for example, a server of a local life application.

According to the operation detection method for the intelligent device provided by the present embodiment, by monitoring the order state of the current order processed by the intelligent device, and triggering the shooting and collection of real-time operation pictures according to the order state, the detection of the operation state can be triggered in a certain process of processing the order, so as to detect the operation state of the intelligent device in the process of processing the order; and by matching the position coordinates of the plurality of real-time key points in the plurality of real-time operation pictures captured in the process of processing the order with pre-recorded operation trajectory ranges, the operation state of the intelligent device can be determined by comparing the operation trajectory ranges. It can be seen that, according to the solution of the present embodiment, the operation detection of the intelligent device can be triggered by using the order state, so as to determine whether the intelligent device maintains normal operation in the process of processing the order; and the detection is performed by shooting real-time operation pictures of the intelligent device without providing corresponding detection modules on the intelligent device, the operation of any intelligent device can be detected, thereby improving the flexibility of the detection. In addition, the matching detection is performed according to the operation trajectory ranges, so that the real-time key points have a normal range, thereby avoiding the problem of over-detection.

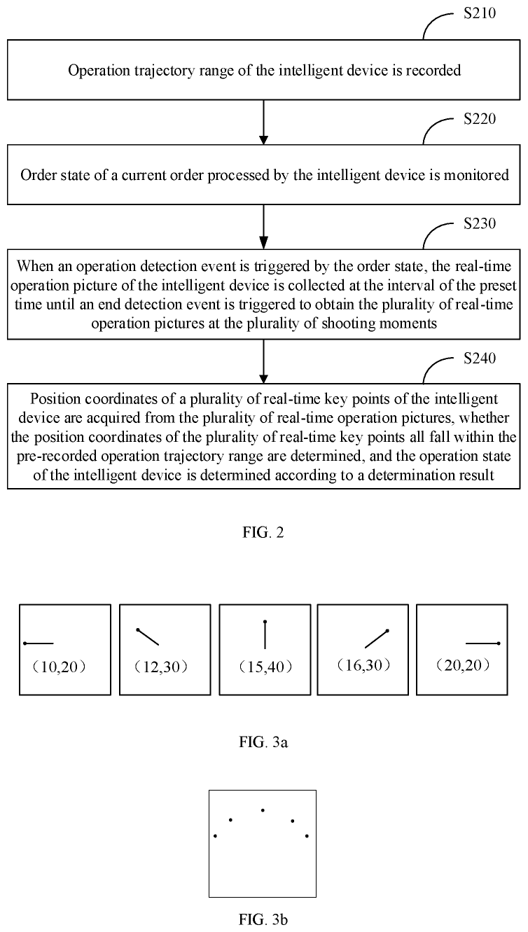

FIG. 2 is a flowchart illustrating another embodiment of an operation detection method for an intelligent device of the present disclosure. As shown in FIG. 2, the method includes the following steps.

Step S210: an operation trajectory range of the intelligent device is recorded.

The operation trajectory range refers to a normal operation range of key points of the intelligent device in the process of historically processing the order.

Specifically, when recording, the normal operation range of the intelligent device, that is, the operation trajectory range, can be obtained by collecting and processing operation pictures in a process of processing a plurality of recording orders. The plurality of recording orders can be orders historically processed or experimental orders. In the process of processing the plurality of recording orders, for each of the plurality of recording orders, an operation picture of the intelligent device at each shooting moment is collected to obtain a plurality of operation pictures of the recording order, that is, for each recording order, the plurality of operation pictures at a plurality of shooting moments can be collected; position coordinates of a plurality of key points of the intelligent device are acquired from the plurality of operation pictures; the position coordinates of the plurality of key points of the plurality of recording orders are merged; and the operation trajectory range is recorded according to a merged result. In the process of processing each recording order, if n operation pictures are collected, n key points are obtained, and then m*n key points will be obtained for m recording orders; further, the operation trajectory range can be obtained by merging the position coordinates of these key points, wherein a merging process refers to a process of tracing the obtained position coordinates of the plurality of key points in the same plane, and processing the position coordinates to obtain position ranges corresponding to the plurality of key points.

In some optional embodiments of the present disclosure, the operation trajectory range is recorded according to a stage of processing an order, wherein the processing process between any two order states can be determined as a stage according to the change of the order state. In the present disclosure, the description is mainly made in this way. Typically, a stage from payment completion to production completion is divided into a production stage, and a stage from production completion to delivery completion is divided into a delivery stage, wherein the delivery stage refers to a process of delivering finished products that have been produced to the user's pick-up location (for example, pick-up container and pick-up window). This method of dividing stages can be used for subsequent matching detection according to the process of processing the order processing, so as to detect whether the operation of intelligent device in the corresponding process is normal. Alternatively, the processing process within a preset processing time after entering a certain order state can be determined as a stage, wherein the preset processing time can be determined according to an average processing time between any two order states, for example, if the average processing time from payment completion to production completion is 5 seconds, the preset processing time is set to 5 seconds. This method of dividing the stages can accurately determine whether an end detection event is triggered by comparing the detection time with the preset processing time in the subsequent real-time detection process. Alternatively, the preset processing time can be determined according to a position change range of the intelligent device in the process of processing the order, and an action time of continuous actions that the intelligent device changes within a preset amplitude variation range is determined as the preset processing time. This method of dividing the stages can determine the continuous actions concentrated in the nearer position area as a stage, and thus the influence of the larger span of the position area on the accuracy of subsequent matching detection can be avoided.

In these embodiments of dividing the stages, the operation trajectory range is recorded in stages, for each stage of the order processed by the intelligent device, the operation picture of the intelligent device at each shooting moment in the process of processing the plurality of recording orders is collected to obtain the plurality of operation pictures in this stage. For example, for the production stage and the delivery stage respectively, the operation picture captured by the shooting device at each shooting moment in the corresponding stage is collected. The position coordinates of the plurality of key points of the intelligent device are acquired from the plurality of operation pictures, the position coordinates of the plurality of key points are merged, and the operation trajectory range in the stage is recorded according to the merged result, wherein the merging process is the process of tracing the position coordinates of the plurality of key points acquired in the stage in the same plane for each stage, and processing the position coordinates to obtain the position ranges corresponding to the plurality of key points. The operation trajectory range recorded in this way can be used for matching detection for the stages, and thus the detection accuracy can be improved by refining the detection granularity.

Alternatively, in some other optional embodiments of the present disclosure, the operation trajectory range may be recorded according to a type of the order, wherein the type of the order is divided according to the process of processing the order. Specifically, if the intelligent device has the same process when processing an order, the actions in the processing process are the same, and the normal trajectory range can be represented by the same operation trajectory range. Based on this, in these optional embodiments, an operation trajectory range for each of various types of orders processed by the intelligent device is pre-recorded. For example, in an automatic drink production store, the processes for processing coffee orders and milk tea orders are obviously different, so it is necessary to record the operation trajectory ranges separately. The preset trajectory range recorded in this way can be used for matching detection in the process of processing different types of orders to determine whether the operation of the intelligent device meets the operation trajectory range of the corresponding type of the order.

Alternatively, in some optional embodiments of the present disclosure, the methods in the two optional embodiments mentioned above can be combined, that is, the operation trajectory range can be recorded according to the order type and the divided stage, so that the detection accuracy can be further improved. For example, the operation trajectory range is recorded separately for the production stage and the delivery stage of milk tea, and the operation trajectory range is recorded for the production stage and delivery stage of coffee.

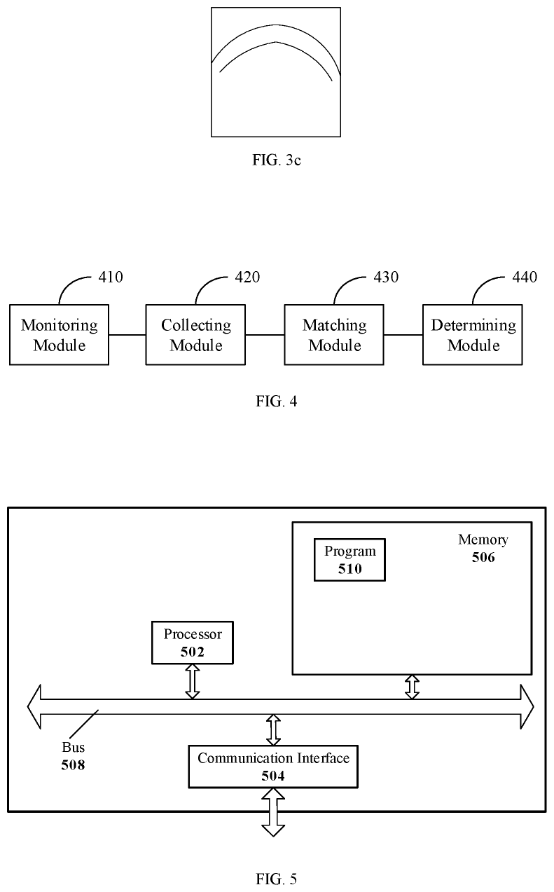

FIG. 3a is a schematic diagram illustrating a plurality of operation pictures taken in a production stage of a recording order in a specific embodiment. When the payment of the order is completed, one operation picture is taken at the interval of 1 second; when five operation pictures are taken, the order state is updated to production completion, and the shooting is stopped at this time. As shown in FIG. 3a, the key points of the intelligent device in the five operation pictures are black solid dots, and their position coordinates are (10, 20), (12, 30), (15, 40), (16, 30) and (20, 20), respectively. FIG. 3b is an integrated diagram illustrating a plurality of key points corresponding to the plurality of operation pictures of FIG. 3a. As shown in FIG. 3b, the position coordinates of the five key points are integrated into the same plane to obtain a movement trajectory of the key points in the production stage of the recording order. FIG. 3c is a schematic diagram illustrating an operation trajectory range formed by movement trajectories of the key points in the production stage of a plurality of recording orders. As shown in FIG. 3c, the operation trajectory range of the intelligent device is a range between the two arcs.

After the operation trajectory range is obtained by recording, device information, stage information, order type information and/or operation trajectory range of the intelligent device are stored in association, so as to be used for query in subsequent matching.

Step S220: an order state of a current order processed by the intelligent device is monitored.

In general, the order state includes, but is not limited to, pending payment, payment completion, production completion, and/or delivery completion.

Specifically, after receiving the order, monitoring an order state thereof is started, especially when the order state changes, it is necessary to determine whether an operation detection event is to be triggered by the updated order state. In some optional embodiments where an end detection event is triggered by some order states, it is also necessary to determine whether the end detection event is to be triggered by the updated order state. It should be noted here that, in some specific embodiments, both the operation detection event and the end detection event may be triggered by the same order state, at this time, the operation detection event is a start event of the upcoming detection, and the end detection event is an end event of the ongoing detection.

Step S230: when an operation detection event is triggered by the order state, the real-time operation picture of the intelligent device is collected at the interval of the preset time until an end detection event is triggered to obtain the plurality of real-time operation pictures at the plurality of shooting moments.

The operation detection event refers to an event that the operation detection is started to determine appropriate detection timing. However, the present embodiment does not limit the specific type of the operation detection event. The operation detection event can be any one or more order states. Optionally, the operation detection event is that the order state is payment completion and/or production completion.

The end detection event refers to an event of stopping the operation detection. In some optional embodiments, when the operation detection event is that the order state is payment completion, the corresponding end detection event is that the order state is production completion; and/or, when the operation detection event is that the order state is production completion, the corresponding end detection event is the delivery completion. In these embodiments where the end detection event is triggered by the order state, the order state can only be known by querying the state data of the backend. When collecting the real-time operation picture of the intelligent device at the interval of the preset time, whether an accumulated value of the preset time reaches a preset end time is determined, if the accumulated value of the preset time reaches the preset end time, the order state at a current time is periodically queried, and whether the end detection event is triggered is determined according to a query result. In these embodiments, since the order state needs to be obtained by querying the backend, it can be estimated whether the order state has been updated or not by the accumulated value of the preset time, wherein the preset end time is set according to an average processing time of a stage of processing the current order. For example, a time close to and less than the average processing time is set as the preset end time. When the preset end time is reached, it indicates that the order state is about to be updated. At this time, the order state is periodically queried to determine whether the end detection event is triggered. In this way, on the premise of avoiding a large number of frequent queries, the end detection event can be accurately detected.

Alternatively, in some other optional embodiments of the present disclosure, the end detection event is that a time from which the operation detection event is triggered reaches a specific time, which is consistent with the time corresponding to the recording of the corresponding operation trajectory range. For example, if the recording is performed by dividing into stages according to the preset processing time described above, the specific time is the same as the preset processing time. In this way, after the operation detection event is triggered, the detection can be ended according to the time, without continuously querying the order state in the shooting process.

Step S240: position coordinates of a plurality of real-time key points of the intelligent device are acquired from the plurality of real-time operation pictures, whether the position coordinates of the plurality of real-time key points all fall within the pre-recorded operation trajectory range are determined, and the operation state of the intelligent device is determined according to a determination result.

Specifically, when matching, the stage corresponding to the plurality of real-time operation pictures and/or the operation trajectory range matched with the order type are acquired. Optionally, when the stage is the production stage, a specific case is that the operation detection event is that state information of the order is payment completion, and the end detection event is production completion, at this time, the operation trajectory range of the production stage is acquired, and the position coordinates of the plurality of real-time key points are matched with the operation trajectory range of the production stage. And/or, when the stage is the delivery stage, a specific case is that the operation detection event is production completion, and the end detection event is the delivery completion, at this time, the operation trajectory range of the delivery stage is acquired, and the position coordinates of the plurality of real-time key points are matched with the operation trajectory range of the delivery stage. And/or, the order type of the current order is identified, the operation trajectory range corresponding to the order type is acquired, and the position coordinates of the plurality of real-time key points are matched with the operation trajectory range corresponding to the order type of the current order.

Further, in the process of matching detection, the position coordinate of each of the plurality of real-time key points may be matched with the operation trajectory range; if the position coordinate of at least one of the plurality of real-time key points does not fall within the pre-recorded operation trajectory range, it is determined that the intelligent device has an operation failure and alarm processing is performed; and if the position coordinates of the plurality of real-time key points all fall within the pre-recorded operation trajectory range, it is determined that the intelligent device is operating normally. Through this detection method, the operation failure of the intelligent device whose operation trajectory exceeds the normal trajectory range can be detected.

Alternatively, in some optional embodiments, if the position coordinates of the plurality of real-time key points all fall within the pre-recorded operation trajectory range, operation detection is further performed in the following manner. Position coordinates of a plurality of key points included in the pre-recorded operation trajectory range are divided according to shooting moments, the position coordinates of several key points at each of the shooting moments are obtained, and a position range at each of the shooting moments is determined according to the position coordinates of the several key points; further, whether the position coordinate of the real-time key point at each of the shooting moments falls within the position range at the shooting moment is determined, and the operation state of the intelligent device is determined according to a determination result. Specifically, when the number of real-time key points that do not fall within the position range at the corresponding shooting moment exceeds a preset number, it is determined that the intelligent device has an operation failure and alarm processing is performed; and when the number of real-time key points that do not fall within the position range of the corresponding shooting moment does not exceed the preset number, it is determined that the intelligent device is operating normally. Through this detection method, when the operation trajectory of the intelligent device is within the normal trajectory range, the operation failure of the intelligent device whose operation points at some shooting moments exceed the normal position range at the shooting moment can be detected by further matching the position coordinates of the real-time key points at each of the shooting moments, for example, the failure that the intelligent device stops operating from a certain time.

Alternatively, in some other optional embodiments, if the position coordinates of the plurality of real-time key points all fall within the pre-recorded operation trajectory range, operation detection is further performed in the following manner. Position coordinates of a plurality of key points included in a pre-recorded operation range diagram are divided according to shooting moments, and a central coordinate of the position range at each of the shooting moments is determined, which is the same as the above process of determining the position range at each of the shooting moments. After the position range at each of the shooting moments is determined, the center coordinate of the position range is taken as a standard position coordinate at the shooting moment, differences between the position coordinates of real-time key points at the plurality of shooting moments and the central coordinates are calculated, and the operation state of the intelligent device is determined according to a calculation result, wherein the difference includes but is not limited to the sum of absolute differences, standard deviation or variance. When the difference is greater than a preset threshold, it is determined that the intelligent device has an operation failure and alarm processing is performed; and when the difference is less than or equal to the preset threshold, it is determined that the intelligent device is operating normally. Through this detection method, when the operation trajectory of the intelligent device is within the normal trajectory range, the failure of the intelligent device whose operation trajectory deviates far from the standard position coordinate can be detected by the difference between the position coordinate of the real-time key point at each of the shooting moments and the standard position coordinate.

According to the operation detection method for the intelligent device provided by the present embodiment, by pre-recording the operation trajectory range of each stage of processing the order and/or each order type for detection and matching, the operation failures in various processing scenarios can be accurately detected; by monitoring the order state of the current order processed by the intelligent device, and triggering the operation detection event through the order state, the detection of the operation state can be triggered in a certain process of processing the order; and by determining whether the position coordinates of the plurality of real-time key points all fall within the pre-recorded operation trajectory range, the failure of the intelligent device whose operation trajectory exceeds the normal trajectory range can be detected, and further, the operation failure in which the operation points at some shooting moments exceed the normal position range at the shooting moment can be more accurately detected by further matching the position coordinate of the real-time key point at each of the shooting moments, or the failure that the operation trajectory deviates far from the standard position coordinate can be detected. It can be seen that, according to the solution of the present embodiment, the operation detection of the intelligent device can be triggered by using the order state to determine whether the intelligent device maintains normal operation in the process of processing the order; moreover, the detection is performed by shooting real-time operation pictures of the intelligent device without providing the corresponding detection modules on the intelligent device, which can be used to detect the operation of any intelligent device, thereby improving the flexibility of the detection.

FIG. 4 is a schematic structural diagram illustrating an embodiment of an operation detection apparatus for an intelligent device of the present disclosure. As shown in FIG. 4, the apparatus includes:

a monitoring module 410 configured to monitor an order state of a current order processed by the intelligent device;

a collecting module 420 configured to collect a real-time operation picture of the intelligent device at an interval of a preset time according to the order state to obtain a plurality of real-time operation pictures at a plurality of shooting moments;

a matching module 430 configured to acquire position coordinates of a plurality of real-time key points of the intelligent device from the plurality of real-time operation pictures and match the position coordinates of the plurality of real-time key points with a pre-recorded operation trajectory range; and

a determining module 440 configured to determine an operation state of the intelligent device according to information of real-time key points falling within the operation trajectory range.

In an optional implementation manner, the apparatus further includes:

a recording module configured to, in a process of processing a plurality of recording orders, for each of the plurality of recording orders, collect an operation picture of the intelligent device at each of the plurality of shooting moments to obtain a plurality of operation pictures of the recording order; acquire position coordinates of a plurality of key points of the intelligent device from the plurality of operation pictures; merge the position coordinates of the plurality of key points of the plurality of recording orders; and record the operation trajectory range according to a merged result.

In an optional implementation manner, the collecting module is further configured to:

when an operation detection event is triggered by the order state, collect the real-time operation picture of the intelligent device at the interval of the preset time until an end detection event is triggered to obtain the plurality of real-time operation pictures at the plurality of shooting moments.

In an optional implementation manner, the apparatus further includes: a recording module configured to record the operation trajectory range according to a stage of processing an order, wherein the stage is a production stage, the operation detection event is that state information of the order is payment completion, and the end detection event is production completion; and

the matching module is further configured to match the position coordinates of the plurality of real-time key points with the operation trajectory range in the production stage.

In an optional implementation manner, the apparatus further includes: a recording module configured to record the operation trajectory range according to a stage of processing an order, wherein the stage is a delivery stage, the operation detection event is production completion, and the end detection event is delivery completion; and

the matching module is further configured to match the position coordinates of the plurality of real-time key points with the operation trajectory range in the delivery stage.

In an optional implementation manner, the apparatus further includes:

an querying module configured to determine whether an accumulated value of the preset time reaches a preset end time when collecting the real-time operation picture of the intelligent device at the interval of the preset time; if the accumulated value of the preset time reaches the preset end time, periodically query the order state at a current time; and determine whether the end detection event is triggered according to a query result, wherein the preset end time is set according to an average processing time of a stage of processing the current order.

In an optional implementation manner, the apparatus further includes: a recording module configured to pre-record an operation trajectory range for each of various types of orders processed by the intelligent device; and

the matching module is further configured to match the position coordinates of the plurality of real-time key points with an operation trajectory range corresponding to an order type of the current order.

In an optional implementation manner, the matching module is further configured to determine whether the position coordinates of the plurality of real-time key points all fall within the pre-recorded operation trajectory range; and

the determining module is further configured to, if an position coordinate of at least one of the plurality of real-time key points does not fall within the pre-recorded operation trajectory range, determine that the intelligent device has an operation failure and performing alarm processing.

In an optional implementation manner, the apparatus further includes: a dividing module configured to divide the position coordinates of the plurality of real-time key points included in the pre-recorded operation trajectory range according to shooting moments, and determining a position range at each of the shooting moments; and

the determining module is further configured to, if the position coordinates of the plurality of real-time key points all fall within the pre-recorded operation trajectory range, determine whether the position coordinate of the real-time key point at each of the shooting moments falls within the position range at the shooting moment, and determine the operation state of the intelligent device according to a determination result.

In an optional implementation manner, the apparatus further includes: a dividing module configured to divide position coordinates of a plurality of real-time key points included in a pre-recorded operation range diagram according to shooting moments, and determining a central coordinate of a position range at each of the shooting moments; and

the determining module is further configured to, if the position coordinates of the plurality of real-time key points all fall within the pre-recorded operation trajectory range, calculate differences between the position coordinates of the real-time key points at the plurality of shooting moments and central coordinates, and determine the operation state of the intelligent device according to a calculation result.

An embodiment of the present disclosure provides a non-volatile computer readable storage medium having at least one executable instruction stored thereon, the executable instruction can perform the operation detection method for the intelligent device in any of the method embodiments described above.

FIG. 5 is a schematic structural diagram illustrating an embodiment of a server of the present disclosure, and the specific implementation of the server is not limited by the specific embodiments of the present disclosure.

As shown in FIG. 5, the server may include: a processor 502, a communication interface 504, a memory 506 and a communication bus 508.

The processor 502, the communication interface 504 and the memory 506 communicate with each other through the communication bus 508. The communication interface 504 is used to communicate with network elements of other devices such as clients or other servers. The processor 502 is used to execute the program 510, and specifically may execute the relevant steps in the above embodiments of the operation detection method for the intelligent device for the server.

Specifically, the program 510 may include program code including computer operation instructions.

The processor 502 may be a CPU (Central Processing Unit), or an ASIC (Application Specific Integrated Circuit), or one or more integrated circuits configured to implement the embodiments of the present disclosure. The one or more processors included in the server may be the same type of processors, such as one or more CPUs; or may be different types of processors, such as one or more CPUs and one or more ASICs.

The memory 506 is used to store the program 510. The memory 506 may include high-speed RAM (Random Access Memory) memory, and may also include non-volatile memory such as at least one disk memory.

The program 510 may specifically be used to cause the processor 502 to perform the following operations:

monitoring an order state of a current order processed by the intelligent device, and collecting a real-time operation picture of the intelligent device at an interval of a preset time according to the order state to obtain a plurality of real-time operation pictures at a plurality of shooting moments;

acquiring position coordinates of a plurality of real-time key points of the intelligent device from the plurality of real-time operation pictures, matching the position coordinates of the plurality of real-time key points with a pre-recorded operation trajectory range, and determining an operation state of the intelligent device according to information of real-time key points falling within the operation trajectory range.

In an optional implementation manner, the program 510 may further specifically be configured to cause the processor 502 to perform the following operations: in a process of processing a plurality of recording orders, for each of the plurality of recording orders, collecting an operation picture of the intelligent device at each of the plurality of shooting moments to obtain a plurality of operation pictures of the recording order, and acquiring position coordinates of a plurality of key points of the intelligent device from the plurality of operation pictures; and

merging the position coordinates of the plurality of key points of the plurality of recording orders; and recording the operation trajectory range according to a merged result.

In an optional implementation manner, the program 510 may be further specifically configured to cause the processor 502 to perform the following operations: when an operation detection event is triggered by the order state, collecting the real-time operation picture of the intelligent device at the interval of the preset time until an end detection event is triggered to obtain the plurality of real-time operation pictures at the plurality of shooting moments.

In an optional implementation manner, a stage is a production stage, the operation detection event is that state information of an order is payment completion, and the end detection event is production completion; and

the program 510 may be further specifically configured to cause the processor 502 to perform the following operations: recording the operation trajectory range according to a stage of processing an order; and matching the position coordinates of the plurality of real-time key points with the operation trajectory range in the production stage.

In an optional implementation manner, a stage is a delivery stage, the operation detection event is production completion, and the end detection event is delivery completion; and

the program 510 may be further specifically configured to cause the processor 502 to perform the following operations: recording the operation trajectory range according to a stage of processing an order; and matching the position coordinates of the plurality of real-time key points with the operation trajectory range in the delivery stage.

In an optional implementation manner, the program 510 may be further specifically configured to cause the processor 502 to perform the following operations: determining whether an accumulated value of the preset time reaches a preset end time when collecting the real-time operation picture of the intelligent device at the interval of the preset time; if the accumulated value of the preset time reaches the preset end time, periodically querying the order state at a current time; and determining whether the end detection event is triggered according to a query result, wherein the preset end time is set according to an average processing time of a stage of processing the current order.

In an optional implementation manner, the program 510 may be further specifically configured to cause the processor 502 to perform the following operations: pre-recording an operation trajectory range for each of various types of orders processed by the intelligent device; and

matching the position coordinates of the plurality of real-time key points with an operation trajectory range corresponding to an order type of the current order.

In an optional implementation manner, the program 510 may be further specifically configured to cause the processor 502 to perform the following operations: determining whether the position coordinates of the plurality of real-time key points all fall within the pre-recorded operation trajectory range; and if an position coordinate of at least one of the plurality of real-time key points does not fall within the pre-recorded operation trajectory range, determining that the intelligent device has an operation failure and performing alarm processing.

In an optional implementation manner, the program 510 may be further specifically configured to cause the processor 502 to perform the following operations: dividing the position coordinates of the plurality of real-time key points included in the pre-recorded operation trajectory range according to shooting moments, and determining a position range at each of the shooting moments; and

if the position coordinates of the plurality of real-time key points all fall within the pre-recorded operation trajectory range, determining whether the position coordinate of the real-time key point at each of the shooting moments falls within the position range at the shooting moment, and determining the operation state of the intelligent device according to a determination result.

In an optional implementation manner, the program 510 may be further specifically configured to cause the processor 502 to perform the following operations: dividing position coordinates of a plurality of real-time key points included in a pre-recorded operation range diagram according to shooting moments, and determining a central coordinate of a position range at each of the shooting moments; and

if the position coordinates of the plurality of real-time key points all fall within the pre-recorded operation trajectory range, calculating differences between the position coordinates of the real-time key points at the plurality of shooting moments and central coordinates, and determining the operation state of the intelligent device according to a calculation result.

The algorithms or displays provided herein are not inherently related to any particular computer, virtual system, or other device. Various general purpose systems can also be used together with teaching set forth herein. In addition, the embodiments of the present disclosure are not directed to any particular programming language. It should be understood that the content of the present disclosure described herein may be implemented by using various programming languages and the above description of a particular language is to disclose an optimal implementation of the present disclosure.

Numerous details are set forth in the specification provided herein. However, it can be understood that, embodiments in accordance with the present disclosure may be practiced without some details described herein. In some examples, well-known methods and structures are not shown in detail not to obscure the understanding of this specification.

Similarly, it should be understood that in the foregoing description of exemplary embodiments in accordance with the present disclosure, various features of the embodiments of the present disclosure are sometimes grouped together into a single embodiment, a single figure, or description thereof, to simplify the present disclosure and assist in understanding one or more of various aspects of the present disclosure. However, the disclosed method should not be construed as reflecting the intention that the claimed disclosure requires more features than those explicitly recorded in each claim. More definitely, as reflected by the following claims, aspects of the present disclosure lie in being less than all features of a single embodiment disclosed above. Therefore, the claims following the Detailed Description are hereby expressly incorporated into the Detailed Description, with each claim standing on its own as a separate embodiment of the present disclosure.

Those skilled in the art can understand that the modules in the devices in the embodiments may be adaptively changed and disposed in one or more devices different from those of the embodiments. Modules or units or components in the embodiments may be combined into one module or unit or component, and in addition, they may be divided into a plurality of sub-modules or sub-units or sub-components. All features disclosed in the present disclosure (including the accompanying claims, abstract and drawings), and all processes or units of any method or device disclosed herein may be combined in any combination, unless at least some of such features and/or processes or units are mutually exclusive. Unless otherwise explicitly stated, each feature disclosed in the present disclosure (including the accompanying claims, abstract and drawings) may be replaced with an alternative feature serving the same, equivalent or similar purpose.

In addition, those skilled in the art can understand that, although some embodiments herein include some but not other features included in other embodiments, combinations of features of different embodiments are meant to be within the scope of the present disclosure and to form different embodiments. For example, in the claims, any one of the claimed embodiments may be used in any combination.

The various component embodiments of the present disclosure may be implemented in hardware or in software modules running on one or more processors or in a combination thereof Those skilled in the art should understand that a microprocessor or a digital signal processor (DSP) may be used in practice to implement some or all of the functions of some or all of the components according to the embodiments of the present disclosure. The present disclosure may also be implemented as a device or apparatus program (for example, a computer program and a computer program product) for performing part or all of the methods described herein. Such a program implementing the present disclosure may be stored on a computer-readable medium or may have the form of one or more signals. Such signals may be downloaded from Internet websites, provided on carrier signals, or provided in any other form.

It should be noted that the above-mentioned embodiments illustrate rather than limit the present disclosure, and those skilled in the art may devise alternative embodiments without departing from the scope of the appended claims. In the claims, any reference signs placed between parentheses shall not be construed as limiting the claims. The word “comprise” does not exclude the presence of elements or steps not listed in the claims. The word “a” or “an” preceding an element does not exclude the presence of a plurality of such elements. The present disclosure can be implemented by way of hardware including several different elements and an appropriately programmed computer. In the unit claims enumerating several apparatuses, several of these apparatuses can be specifically embodied by the same item of hardware. The use of the words such as “first”, “second”, “third”, and the like does not denote any order. These words can be interpreted as names. Unless otherwise specified, the steps in the above embodiments should not be understood as limiting the execution order.

What is claimed is:

1. An operation detection method for an intelligent device, comprising:
monitoring an order state of a current order processed by the intelligent device;
collecting a real-time operation picture of the intelligent device at an interval of a preset time according to the order state to obtain a plurality of real-time operation pictures at a plurality of shooting moments;
acquiring position coordinates of a plurality of real-time key points of the intelligent device from the plurality of real-time operation pictures; and
matching the position coordinates of the plurality of real-time key points with a pre-recorded operation trajectory range, and determining an operation state of the intelligent device according to information of real-time key points falling within the operation trajectory range.

2. The method according to claim 1, further comprising:
in a process of processing a plurality of recording orders, for each of the plurality of recording orders, collecting an operation picture of the intelligent device at each of the plurality of shooting moments to obtain a plurality of operation pictures of the recording order;
acquiring position coordinates of a plurality of key points of the intelligent device from the plurality of operation pictures;
merging the position coordinates of the plurality of key points of the plurality of recording orders; and
recording the operation trajectory range according to a merged result.

3. The method according to claim 1, wherein collecting the real-time operation picture of the intelligent device at the interval of the preset time according to the order state to obtain the plurality of real-time operation pictures at the plurality of shooting moments further comprises:
when an operation detection event is triggered by the order state, collecting the real-time operation picture of the intelligent device at the interval of the preset time until an end detection event is triggered to obtain the plurality of real-time operation pictures at the plurality of shooting moments.

4. The method according to claim 3, further comprising:
recording the operation trajectory range according to a stage of processing an order, wherein the stage is a production stage, the operation detection event is that state information of the order is payment completion, and the end detection event is production completion;
wherein matching the position coordinates of the plurality of real-time key points with the pre-recorded operation trajectory range further comprises:
matching the position coordinates of the plurality of real-time key points with the operation trajectory range in the production stage.

5. The method according to claim 3, further comprising:
recording the operation trajectory range according to a stage of processing an order, wherein the stage is a delivery stage, the operation detection event is production completion, and the end detection event is delivery completion;
wherein matching the position coordinates of the plurality of real-time key points with the pre-recorded operation trajectory range further comprises:
matching the position coordinates of the plurality of real-time key points with the operation trajectory range in the delivery stage.

6. The method according to claim further comprising:
determining whether an accumulated value of the preset time reaches a preset end time when collecting the real-time operation picture of the intelligent device at the interval of the preset time;
if the accumulated value of the preset time reaches the preset end time, periodically querying the order state at a current time; and
determining whether the end detection event is triggered according to a query result,
wherein the preset end time is set according to an average processing time of a stage of processing the current order.

7. The method according to claim 1, further comprising:
pre-recording an operation trajectory range for each of various types of orders processed by the intelligent device;
wherein matching the position coordinates of the plurality of real-time key points with the pre-recorded operation trajectory range further comprises:
matching the position coordinates of the plurality of real-time key points with an operation trajectory range corresponding to an order type of the current order.

8. The method according to claim 1, wherein matching the position coordinates of the plurality of real-time key points with the pre-recorded operation trajectory range, and determining the operation state of the intelligent device according to information of real-time key points falling within the operation trajectory range further comprises:
determining whether the position coordinates of the plurality of real-time key points all fall within the pre-recorded operation trajectory range; and
if an position coordinate of at least one of the plurality of real-time key points does not fall within the pre-recorded operation trajectory range, determining that the intelligent device has an operation failure and performing alarm processing.

9. The method according to claim 8, further comprising:
dividing the position coordinates of the plurality of real-time key points included in the pre-recorded operation trajectory range according to shooting moments, and determining a position range at each of the shooting moments;
wherein matching the position coordinates of the plurality of real-time key points with the pre-recorded operation trajectory range, and determining the operation state of the intelligent device according to information of real-time key points falling within the operation trajectory range further comprises:
if the position coordinates of the plurality of real-time key points all fall within the pre-recorded operation trajectory range, determining whether the position coordinate of the real-time key point at each of the shooting moments falls within the position range at the shooting moment, and determining the operation state of the intelligent device according to a determination result.

10. The method according to claim 8, further comprising:
dividing position coordinates of a plurality of real-time key points included in a pre-recorded operation range diagram according to shooting moments, and determining a central coordinate of a position range at each of the shooting moments;
wherein matching the position coordinates of the plurality of real-time key points with the pre-recorded operation trajectory range, and determining the operation state of the intelligent device according to information of real-time key points falling within the operation trajectory range further comprises:
if the position coordinates of the plurality of real-time key points all fall within the pre-recorded operation trajectory range, calculating differences between the position coordinates of the real-time key points at the plurality of shooting moments and central coordinates, and determining the operation state of the intelligent device according to a calculation result.

11-20. (canceled)

21. A server, comprising a processor, a memory, a communication interface and a communication bus, wherein
the processor, the memory and the communication interface communicate with each other through the communication bus;
the memory is configured to store at least one executable instruction; and
the executable instruction causes the processor to perform following operations;
monitoring an order state of a current order processed by the intelligent device;
collecting a real-time operation picture of the intelligent device at an interval of a preset time according to the order state to obtain a plurality of real-time operation pictures at a plurality of shooting moments;
acquiring position coordinates of a plurality of real-time key points of the intelligent device from the plurality of real-time operation pictures; and
matching the position coordinates of the plurality of real-time key points with a pre-recorded operation trajectory range, and determining an operation state of the intelligent device according to information of real-time key points falling within the operation trajectory range.

22. A non-volatile computer readable storage medium having at least one executable instruction stored thereon, wherein the executable instruction causes a processor to perform operations corresponding to the operation detection method for the intelligent device according to claims 1.

23. A computer program product comprising a computer program stored on a non-volatile computer storage medium, the computer program comprising program instructions which, when executed by a processor, cause the processor to perform operations corresponding to the operation detection method for the intelligent device according to claims 1.
